(19) United States
(12) Patent Application Publication
(10) Pub. No.: US 2025/0010495 A1
(43) Pub. Date: Jan. 9, 2025

(54) SUCTION-CUP GRIPPER DEVICE AND FLIP-OVER ASSEMBLY

(71) Applicant: VELEC SYSTEMS, WATTRELOS (FR)

(72) Inventors: Thomas PIERRON, WATTRELOS (FR); Ludovic LALET, WATTRELOS (FR)

(73) Assignee: VELEC SYSTEMS, WATTRELOS (FR)

(21) Appl. No.: 18/763,183

(22) Filed: Jul. 3, 2024

(30) Foreign Application Priority Data
Jul. 3, 2023 (FR) 2307056

(51) Int. Cl. B25J 15/06; B25J 9/16; B25J 11/00; B25J 19/00

(52) U.S. Cl. CPC B25J 15/0658; B25J 9/1612; B25J 11/0045; B25J 19/007

(57) ABSTRACT

A suction-cup gripper device including: at least one pneumatic cylinder including a cylinder body, a piston sliding in an inner chamber of the cylinder body, a rod secured to the piston, the piston-rod assembly being configured to be retracted ad deployed, a pneumatic suction cup secured to the rod, a depressurization circuit, the depressurization circuit including: the rod is tubular, and communicating with the pneumatic suction cup, an inner duct, sealingly connected to the rod via sliding seals, forming a vacuum chamber,

and the piston is annular and sweeps an annular pressurization chamber of the cylinder body connected to at least one compressed air port.

The present disclosure relates to a suction-cup gripper device, as well as to a flip-over assembly equipped with such a device.

### TECHNICAL FIELD

The present disclosure relates to the field of industrial production automated equipment. More specifically, we herein focus on compact suction-cup gripper devices and cylinders.

### BACKGROUND

Standard cylinders generally have a sealed hollow body, including an inner chamber in which a piston slides. The piston is conventionally provided with a rod projecting from the cylinder body. Air, in the case of pneumatic cylinders (or oil, in the case of hydraulic cylinders), circulates in the chamber and actuates the piston to deploy/retract the rod relative to the cylinder body. Pneumatic cylinders of this type are widely known and used in various application fields, primarily industrial, in particular with gripper and lifting cylinder devices equipped with suction cups.

To this end, the cylinder is connected to pneumatic channels and ports, intended to convey air/fluid within the chamber of the piston, to push the piston in either direction of the chamber. A juxtaposed additional suction-cup system including one or more suction cup(s), is connected to a vacuum source, and is fastened to the rod of the cylinder. The pneumatic cylinder and suction-cup system assembly allows controlling the descent or the rise of the suction cup, by deployment or retraction of the cylinder and grasping an object by suction effect of the pneumatic suction cup.

According to the findings of the Inventors, the axial bulk of such an assembly is not optimized. Furthermore, the air channels and the vacuum source of these devices are mounted independently of one another and outside the cylinder body. These outer elements are not optimized to reduce the bulk or the weight of the devices and might be degraded very rapidly and more easily than an integrated system.

In addition, in an industrial production environment, the multiplication of outer elements, such as cable passages or projecting parts, might be troublesome, and even hazardous for the operators and technicians. Hence, it is particularly interesting to seek to reduce the bulk and the dimensions of the robotic equipment.

Furthermore, once assembled, the known devices are conventionally dismountable only partially, and the inner spaces are then difficult to access.

These devices also generally feature cavities on their outer walls, promoting the accumulation of deposits. In particular, in the agri-food industry, dirts accumulate in these spaces and it is difficult to completely clean them.

### SUMMARY

The present disclosure improves the situation.

A suction-cup gripper device is provided including:
at least one pneumatic cylinder including a cylinder body, a piston slidably mounted in a first inner chamber of the cylinder body, and a rod secured to the piston extending from a proximal end from the inner chamber to the outside of the cylinder body, throughout an opening in the cylinder body,
pneumatic suction-cup system including a pneumatic suction cup secured to the distal end of the rod, and a circuit for depressurizing the pneumatic suction cup and wherein the piston and rod assembly is configured selectively retract in a first position into the cylinder body, and deploy in a second position out of the cylinder body and wherein the depressurization circuit of the pneumatic suction cup includes:
the rod of the piston which is tubular, and communicating at the distal end with the pneumatic suction cup,
an inner duct, coaxial with the rod of the cylinder, secured to the body of the cylinder, penetrating the tubular rod from said proximal end, connected in a fluid-sealed manner with an inner surface of the rod via a sliding seal system, forming a vacuum chamber,
   and wherein the piston is annular, configured to surround the cylinder rod and the inner duct, and to sweep at least one pressurization chamber of the cylinder body connected to at least one compressed air port external to the cylinder body, annular, delimited between the inner duct and an inner surface of the cylinder body configured to slide with the piston.

The features disclosed in the next paragraphs may, optionally, be implemented, independently of one another or in combination.

According to one embodiment, the pneumatic suction cup includes a longitudinal direction perpendicular to the axis of the rod, and an anti-rotation system configured to prevent the rotation of the rod and of the pneumatic suction cup relative to the body of the cylinder, about the axis of the rod.

According to one embodiment, the anti-rotation system includes the cylinder body, with a non-circular section, and the piston, with a non-circular complementary shape.

According to one embodiment, the cylinder body includes:
a main portion including an end wall carrying said opening sealingly crossed by the rod of the piston, said end wall being extended by a peripheral wall, said peripheral wall internally forming the inner surface of the cylinder body configured to slidably cooperate with the piston, up to a second opening, configured to enable extension of the piston, and
a cover portion, configured to sealingly close said second opening, said cover portion being secured to the inner duct at a proximal end of the inner duct opposite to a distal end of the inner duct cooperating with the sliding seal system.

According to one embodiment, said pneumatic cylinder is a double-acting cylinder, said at least one pressurization chamber including:
a first pressurization chamber defined in the cylinder body, on a first side of the piston, the first chamber being connected to an outer first compressed air port, and
a second pressurization chamber defined in the cylinder body, on a second side of the piston, the second chamber being connected to an outer second compressed air port.

According to one embodiment, the cylinder body includes:
a vacuum channel, across the thickness of the wall of the cylinder body, configured to set the inner vacuum chamber in communication with the inner duct and an outer vacuum port in communication with the cylinder body,
at least one pressurization channel, across the thickness of the wall of the cylinder body configured to set said at least one pressurization chamber and said at least one compressed air port in communication, in particular a first compressed air channel communicating with the first pressurization chamber and a second compressed air channel communicating with the second pressurization chamber.

According to one embodiment, said outer vacuum port is secured to the main portion of the cylinder body, said vacuum channel extending in the main portion and in the cover portion, via a seal between the main portion and the cover portion to ensure communication between the outer port and the vacuum chamber, and/or wherein said at least one compressed air port is secured to the main portion of the cylinder body, said at least one pressurization channel extending in the main portion and in the cover portion, via a seal between the main portion and the cover portion to ensure communication between said at least one compressed air port and one of said at least one pressurization chamber.

According to one embodiment, said compressed air port, in particular the first compressed air port and the second compressed air port on the one hand, and the vacuum port, on the other hand, are secured to the main portion, arranged projecting laterally, and according to a bulk according to the direction of the rod contained within the limits of the main portion, the cover portion being devoid of a compressed air port and of a vacuum port projecting outside.

According to one embodiment, the cylinder body includes a Venturi system connected, on the one hand, to a compressed air source and, on the other hand, to the outside atmosphere, configured to ensure depressurization of the vacuum chamber in the inner duct from a compressed air source.

According to one embodiment, the Venturi system comprises a Venturi inlet port to make compressed air circulate in the cylinder body in a throttling channel with a first diameter smaller than the diameter of the Venturi inlet port, up to the vacuum chamber, then towards an outlet channel with a second diameter larger than the first diameter of the throttling channel communicating with the vacuum chamber and as an extension of the throttling channel, up to an air outlet of the cylinder body, said throttling channel with a smaller diameter being configured to accelerate the passage of compressed air originating from the Venturi inlet port thereby creating vacuum in said vacuum chamber, and said outlet channel being configured to evacuate the air sent from the throttling channel in the vacuum chamber towards the air outlet outside the cylinder body.

According to one embodiment, the Venturi inlet port is secured to the cover portion of the cylinder body arranged projecting laterally from said cover portion, and said throttling channel and outlet channel extend inside the cover portion.

According to one embodiment, the suction-cup cylinder of the device is used for gripping and handling food products.

The present disclosure also relates to a flip-over gripper assembly including two devices respectively with two suction-cup cylinders mounted on a support, and including an actuator configured to switch the two pneumatic cylinders:
from a grasp position in which the two pneumatic cylinders, the first pneumatic cylinder and the second pneumatic cylinder, are directed parallel to one another according to a vertical direction, the pneumatic suction cups directed downwards, the grasp position being configured to grasp an object on a surface or to deposit an object on a surface,
into a flip-over position in which the two pneumatic cylinders are directed coaxially, configured to transfer said object grasped by the pneumatic suction cup of the first pneumatic cylinder to the pneumatic suction cup of the second pneumatic cylinder upon deployment of the rod of the first pneumatic cylinder or of the second pneumatic cylinder or upon deployments of the rods of the first pneumatic cylinder and of the second pneumatic cylinder.

The present disclosure also relates to a method for flipping over an object on a surface implementing the assembly and comprising the following steps:
/A1/ placing the assembly in the grasping position of the two pneumatic cylinders,
/A2/ deploying the rod of said first pneumatic cylinder, or of said second pneumatic cylinder, in the second position,
/A3/ grasping the object on the surface with the pneumatic suction cup secured to the deployed rod,
/A4/ retracting the rod secured to the pneumatic suction cup carrying the object in the first position,
/B1/ placing the assembly in the flip-over position of the two pneumatic cylinders,
/B2/ deploying the rods of the two pneumatic cylinders in the second position to transfer the object carried by the pneumatic suction cup of said first pneumatic cylinder, or of said second pneumatic cylinder, to the pneumatic suction cup of said second pneumatic cylinder, or of said first pneumatic cylinder, respectively,
/B3/ retracting the rods of the two pneumatic cylinders in the first position,
/ C1/ placing the assembly in the grasp position of the two pneumatic cylinders,
/ C2/ deploying the rod secured to the suction cup carrying the object, in the second position and depositing the object on the surface.

According to one embodiment, the cylinder body of the pneumatic cylinder, in particular said at least one pressurization channel, where appropriate, said vacuum channel, and/or channels forming the Venturi system in particular said throttling channel and said outlet channel is manufactured by additive manufacturing.

### BRIEF DESCRIPTION OF THE DRAWINGS

Other features, details and advantages will become apparent upon reading the detailed description hereinafter, and upon examining the appended drawings, wherein:

FIG. 1 shows an overview of a flip-over gripper assembly, comprising a support and two suction-cup gripper devices including the gripper cylinders, placed in their vertical position, parallel to one another. One of the two gripper cylinders carries an object, grasped on a first face by its pneumatic suction cup.

FIG. 2 is a view consecutive to FIG. 1, where the two suction-cup gripper devices are placed in a second flip-over position in which the two pneumatic cylinders are directed coaxially, their suction cup directed opposite one another, having the object grasped by the suction cup of the first cylinder in front of the free suction cup of the second cylinder. In such a configuration, the transfer of the object from the first pneumatic suction cup to the second pneumatic suction cup allows grasping the object by a face opposite to the initially grasped face.

FIG. 3 shows a top view of the two suction-cup gripper devices, detached from the support, placed in their flip-over position opposite one another. Each suction-cup gripper device comprises a pneumatic suction cup, secured to a rod retractable/ deployable through the opening of the cylinder body of the pneumatic cylinder. In the illustrated embodiment, the cylinder body comprises a main portion, comprising compressed air and vacuum pneumatic ports, and a cover portion.

FIG. 4 shows a three-quarter top view of a gripper cylinder according to FIG. 3, highlighting the geometry of the pneumatic suction cup.

FIG. 5 shows a perspective view of the suction-cup gripper device, herein shown without its pneumatic suction cup. The rod of the cylinder is retracted in the first position, in the cylinder body of the gripper cylinder.

FIG. 6 shows the view according to FIG. 5, where the rod is deployed in the second position, with respect to and out of the cylinder body of the gripper cylinder.

FIG. 7 shows a cross-section of the suction-cup gripper device, illustrating the inner elements of the cylinder body, the piston of the cylinder, the inner chamber, the rod, and the vacuum chamber formed by the inner duct. This view allows illustrating the fact that the rod is hollow, in direct communication with the vacuum chamber. The piston and the inner chamber have an oval section and have complementary shapes. Such a non-circular section of the piston and of the inner chamber forms an anti-rotation system of the rod and of the pneumatic suction cup, and which allows keeping a determined orientation of the pneumatic suction cup with respect to the body of the cylinder (about the axis of the rod).

FIG. 8 shows a longitudinal section of the suction-cup gripper device according to FIG. 7, showing all of the inner elements of the cylinder body of the pneumatic cylinder. The tubular rod, secured to the pneumatic suction cup and to the piston, is placed in the first position, retracted in the cylinder body. In this position, the piston is located at the proximal end (to the right in the figure) of the inner chamber. The inner duct, forming the depressurization central chamber, and the rod are in sealed contact thanks to a sliding seal system. In this illustration, the cylinder body includes a system of two pressurization channels (communicating with the two pneumatic ports to the left), connected to the inner chamber each by at least two openings. The openings of the two pressurization channels open into the body of the cylinder, in two walls forming the bases of the cylinder. These pressurization channels are visible on both sides of the piston. The cylinder body also includes a vacuum channel (communicating with the rightmost pneumatic port), connected to the depressurization central chamber communicating with the rod. Thus, the two pressurization channels actuate the piston and the rod, and the vacuum channel actuates suction of the suction cup located at the distal end of the rod.

FIG. 9 is a second view of FIG. 8, with the rod in its second position deployed out of the cylinder body of the gripper cylinder. The piston is then located at the (left-side) distal end of the inner chamber. The sealed contact between the rod and the inner duct is ensured by the sliding seals.

FIG. 10 shows another embodiment of FIG. 8. The compressed air ports are located at the ends (to the left and to the right), and the vacuum port is located at the center between the two air ports. Each of the channels communicates via one single opening in the inner chamber, on either side of the piston.

FIG. 11 shows another embodiment of the suction-cup gripper device where the rod is retracted in the first position. A Venturi system is integrated into the cover portion of the cylinder body. The inlet port of the Venturi projects from the cover portion of the cylinder body, and an air outlet is located on the cover portion opposite the inlet port of the Venturi.

FIG. 12 shows a longitudinal section of the suction-cup gripper device according to FIG. 11 depicting all of the inner elements of the cylinder body with the Venturi system. The main portion of the cylinder body is the same as that one depicted in FIG. 8. The cover portion integrates the Venturi system. The inlet port of the Venturi is communicating with a throttling channel, characterized by a reduced diameter, smaller than the diameter of the inlet port. The throttling channel is rectilinear and extends up to the vacuum chamber. Opposite the throttling channel, in the vacuum chamber, a rectilinear second outlet channel extends from the throttling channel, and crosses the cylinder body up to an air outlet opening. The outlet channel as a diameter larger than that of the throttling channel.

### DETAILED DESCRIPTION

The drawings and the description hereinafter essentially contain elements of certain nature. Hence, they could not only be used to better understand the present disclosure, but also contributes to definition thereof, where appropriate.

Also, the present disclosure relates to a suction-cup gripper device 1 including:
at least one pneumatic cylinder 3 including a cylinder body 30, a piston 31 slidably mounted in an inner chamber 33 of the cylinder body 30, and a rod 32 secured to the piston 31,
a pneumatic suction-cup system including a pneumatic suction cup 34 secured to the distal end of the rod 32 and a circuit for depressurizing the pneumatic suction cup 34 and wherein the piston 31 and rod 32 assembly is configured to selectively retract in a first position p1 into the cylinder body 30, and to deploy in a second position p2 out of the cylinder body 30.

Such a suction-cup gripper device 1 finds a particular application at the end of a robotic arm, in particular a multi-axis robotic arm. Such a robotic arm is configured to grasp an object Obj on a horizontal surface, such that the surface of a conveyor on which at least one object Obj rests.

The grasping sequence may typically comprise a descent of the pneumatic suction cup 34 by deployment of the cylinder 3, and an activation of depressurization in the pneumatic suction cup 34.

Such a gripper device 1 may find a particular application to flip over an object Obj. In general the object Obj may be a food product, a pack of thermoformed products, an item, a part, etc.

For example, the object Obj may be a meat product, a pastry or a pack of products wrapped with a film, moving in an automated manner on a conveyor belt, and requiring either to be flipped over on the conveyor, for example for homogeneous baking of two opposite faces, or to be replaced, for example if it is not properly aligned on the conveyor or in order to be deposited on another conveyor.

To this end, the device 1 comprises said at least one pneumatic cylinder 3 which includes the cylinder body 30, the rod 32, secured to a piston 31 slidably mounted in the inner chamber 33 of the cylinder body 30. As illustrated in FIG. 5, 6, 8, 9 or 10, and, in general, the rod 32 extends from a proximal end from the inner chamber 33 to the outside of the cylinder body 30, throughout an opening O in the cylinder body 30.

The pneumatic cylinder 3 further includes the pneumatic suction-cup system with the pneumatic suction cup 34, secured to the distal end of the rod 32 (outside the cylinder body 30), configured to catch/release the object Obj by suction effect. To activate the suction effect of the suction cup 34, the pneumatic cylinder 3 includes to this end a circuit for depressurizing the pneumatic suction cup 34.

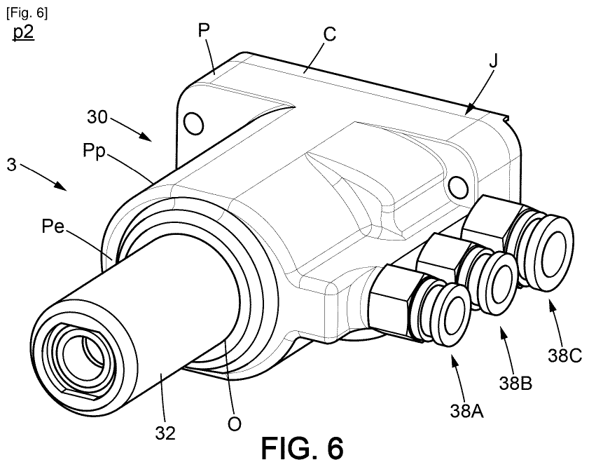

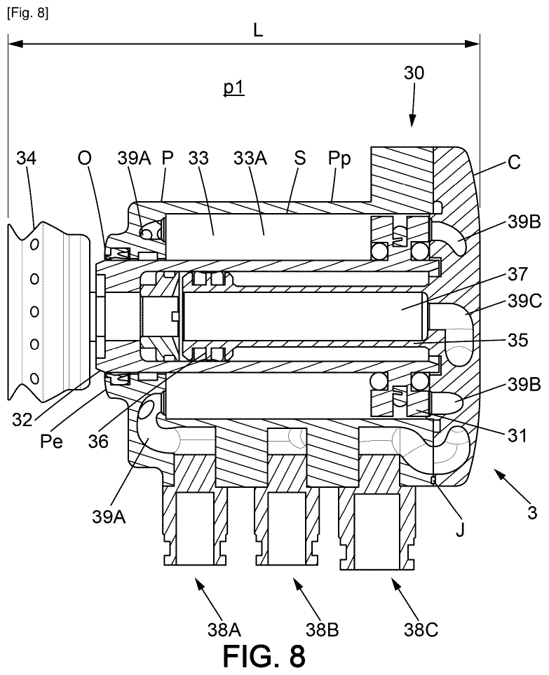

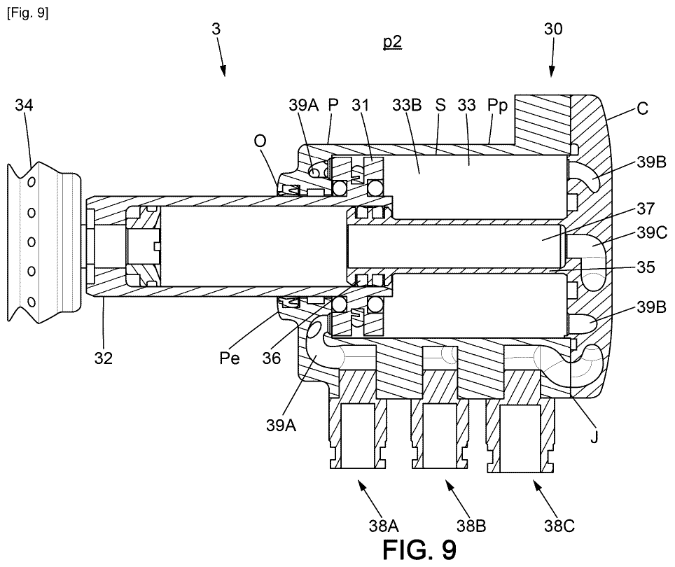

The rod 32-piston 31 assembly is configured to selectively retract in a first position p1 into the cylinder body 30, for example illustrated in FIGS. 5 and 8, and deploy in a second position p2 out of the cylinder body, as illustrated in FIGS. 6 and 9.

Thus, the rod is deployed when an object Obj should be grasped, or deposited, by the pneumatic suction cup 34 on the surface, then it is retracted once the object Obj has been grasped, or deposited.

In addition, the rod 32 is tubular and communicates at its distal end with the pneumatic suction cup 34.

More specifically, the pneumatic cylinder 3 also includes an inner duct 35, coaxial with the rod 32, secured to the cylinder body 30, penetrating the tubular rod 32 from said proximal end.

This inner duct 35 is connected in a fluid-sealed manner to the rod 32 via a sliding seal system 36 and forms a vacuum chamber 37.

Preferably, the sliding seals 36 are seals with one or two lip(s), such as the SPI® seals, configured to be placed, on one side, under vacuum and, on the other side, to be compressed by air.

Such a design, where the rod is tubular, communicating with the pneumatic suction cup 34 and the vacuum chamber 37, is particularly advantageous because it is provided for the depressurization circuit being directly integrated into the rod 32, allowing reducing the bulk of the suction-cup gripper device 1, and in particular according to the axis of the rod of the cylinder.

In general, the overall bulk of the suction-cup gripper device according to the axis of the rod 32 of the pneumatic cylinder, from a grasping face of the pneumatic suction cup 34, and up to a base of the cylinder body 30, opposite to the pneumatic suction cup 34, may be reduced, compared to a design according to the prior art wherein distinct and independent pneumatic suction-cup system and pneumatic cylinder are juxtaposed.

Thus, in FIG. 9, the dimension L represents the overall dimension of the suction-cup gripper device (in the first retracted position p1). The dimension L extends from the grasping face of the pneumatic suction cup 34 up to an outer wall of the base of the body of the cylinder 30, located opposite to the pneumatic suction cup 34.

The piston 31 is annular, configured to surround the rod 32 and the inner duct 35. The piston 31 is configured to sweep at least one pressurization chamber 33A, 33B of the cylinder body 30. Said at least one pressurization chamber 33A, 33B is connected to at least one compressed air port 38A, 38B external to the cylinder body 30, and is also annular. To be specific, the chamber 33A, 33B is delimited between the inner duct 35 and an inner surface S of the cylinder body 30, and is configured to slide with the piston 31.

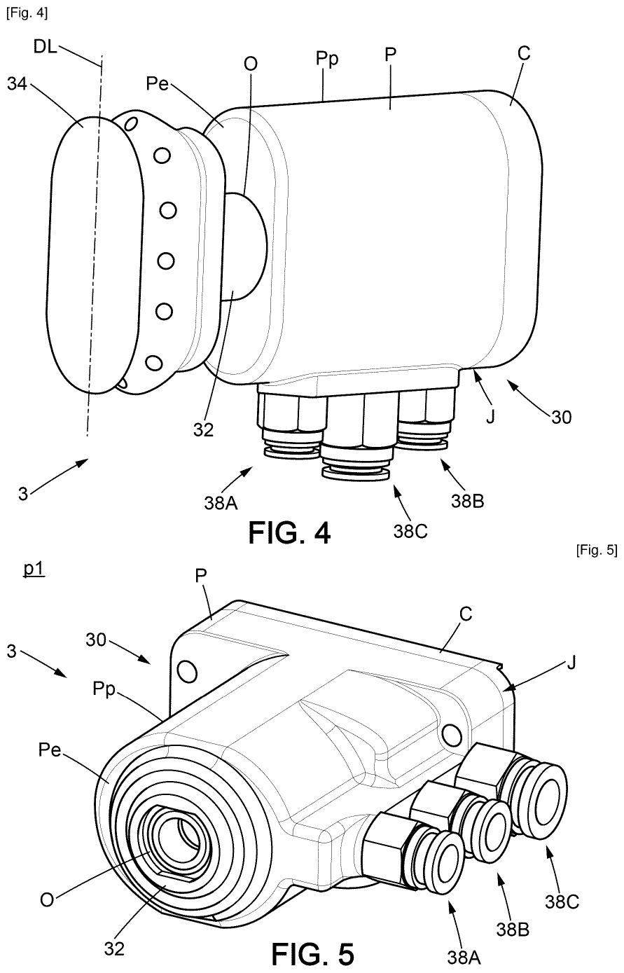

The pneumatic suction cup 34 may be non-circular and include a longitudinal direction DL, perpendicular to the axis of the rod 32, as shown in FIG. 4, and further comprises an anti-rotation system, configured to prevent the rotation of the rod 32 and of the pneumatic suction cup 34 relative to the cylinder body 30 about the axis of the rod 32. In this manner, when it has a preferred grasp axis, the suction cup 34 does not pivot relative to the body of the cylinder 30, about the axis of the rod 32, when grasping or depositing the object Obj.

In FIG. 4, the pneumatic suction cup has an oblong shape. The pneumatic suction cup 34 may also be selected with other shapes, for example with a circular shape, and with variable dimensions, adapted to the object Obj to be grasped and/or to be flipped over. For example, to grip a food product with substantially equal longitudinal and transverse dimensions, such as a minced steak, the pneumatic suction cup 34 is preferably circular, and its diameter may be comprised between 3 and 7 cm, such as 5 cm. And, for example, for another type of food product with different longitudinal and transverse dimensions, such as a pastry, the shape of the preferred suction cup is oblong and with a longitudinal dimension which may be comprised between 4 and 8 cm, such as for example 6 cm and with a smaller transverse dimension, comprised between 1 and 5 cm, such as 3 cm.

The pneumatic suction cup 34 may comprise a hollow body made of an elastomer material, such as vinyl, silicone or nitrile, and comprises several bellows, comprising a suction opening on the grasping face so as to adapt and be in contact with the variable and/or irregular faces of the object Obj to be grasped.

In more details, the anti-rotation of the suction cup 34 may include the cylinder body 30 which has a non-circular section and the piston 31 has a non-circular complementary shape.

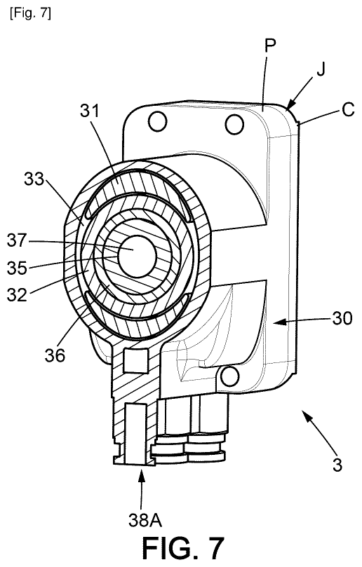

This system is particularly visible in FIG. 7, where one could observe on the section that the cross-sections of the piston 31 and of the inner chamber 33 have complementary oval shapes. Thus, during sweeping of the piston 31 in the inner chamber 33, the piston-rod-suction cup assembly cannot pivot on itself about the axis of the rod 32.

It is also possible to select a circular section shape, but in such an embodiment, another anti-rotation system should be provided for, for example the opening O of the cylinder body 30 and the rod 32 should alternately have, for example, a non-circular section, or notches or any suitable system preventing the rotation of these elements while preserving sealing of the device.

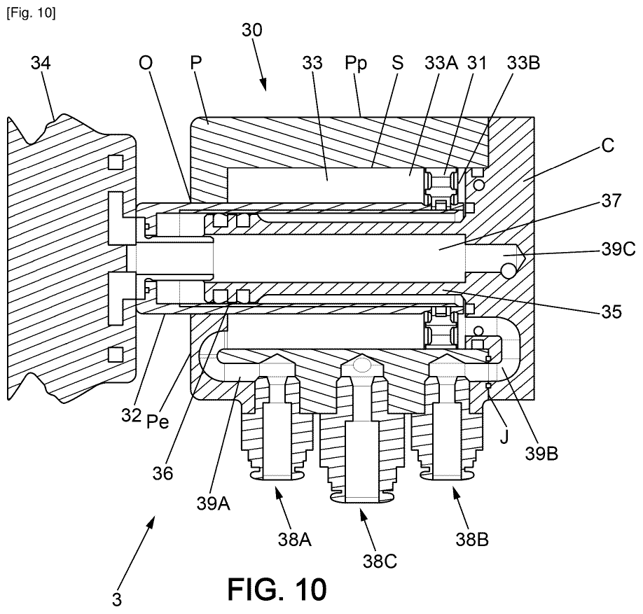

As illustrated in FIGS. 4, 8, 9 and 10, the cylinder body 30 may include:
a main portion P, with an end wall Pe forming a first base of the cylinder, bearing the opening O, sealingly crossed by the rod 32 of the piston 31. The end wall Pe is extended by a peripheral wall Pp which internally forms the inner surface S, configured to slidably cooperate with the piston 31 up to a second opening, opposite the end wall Pe, and configured to enable the extension of the piston 31 (or insertion thereof during mounting), and
a cover portion C, configured to sealingly close the second opening and forming the second base of the cylinder. The cover portion C is secured to the inner duct 35 at the level of a proximal end of the inner duct 35 opposite to a distal end of the inner duct 35 cooperating with the sliding seal system 36.

The main portion P and the cover portion C may be sealingly assembled typically by screwing, in holes for fastening members, opposite one another, distributed between the cover portion C and the main portion P, in particular throughout a shoulder of the main portion P.

Once disassembled, these two portions, the main portion P and the cover portion C, are designed so as to allow access to the elements internal to the body of the cylinder 30, and to facilitate mounting and dismounting of the cylinder 3. Thus, the piston 31, the rod 32 the sliding seals 36 are easily integrated or replaced in the cylinder body 30 when the portions are separated.

According to one embodiment, the pneumatic cylinder 3 is a double-acting cylinder, i.e. the inner chamber 33 includes:
a first pressurization chamber 33A defined in the cylinder body 30 on a first side of the piston (for example shown to the left in FIGS. 8 to 10, at the distal end of the inner chamber), being connected to an outer first compressed air port 38A, and
a second pressurization chamber 33B defined in the cylinder body 30 on a second side of the piston (for example shown to the right in FIGS. 8 to 10, at the proximal end of the inner chamber), being connected to an outer second compressed air port 38B.

When pressurized by the first compressed air port 38A, the first pressure chamber 33A allows urging the piston 31 in the direction of retraction of the pneumatic cylinder 3.

When pressurized by the second compressed air port 38B, the second pressure chamber 33B allows urging the piston 31 in the opposite direction.

In another embodiment which is not shown, the pneumatic cylinder 3 is a single-acting cylinder, meaning that the cylinder is urged in one direction, typically for deployment (or for retraction), by a pressurization chamber 33A, 33B, on only one side of the piston 31 while compressing a return spring, typically a compression spring located on the other side of the piston 31.

The opposite movement of the pneumatic cylinder 3 (for retraction or for deployment) is obtained by the work of the spring, once the compressed air source is not activated.

Thus, and in one embodiment of the single-acting cylinder, the spring may be located at the proximal end of the inner chamber (close to the cover portion C), and the compressed air port sends compressed air to the distal end of the inner chamber (close to the opening O of the cylinder body 30). When air is sent through the compressed air port, the piston 31 then sweeps the inner chamber, from the distal end up to the proximal end of the chamber, and compresses the spring. The compression of the spring places the piston 31 in the second position p2, where the rod 32 is deployed out of the cylinder body 30. As long as air is sent through the compressed air port, the piston 31 is held in its position at the proximal end, against the compressed spring. Once air is no longer sent, the spring expands and pushes the piston 31 towards its original position, at the distal end of the inner chamber. The expansion of the spring retracts the rod 32 and the piston 31 in the first position p1, inside the cylinder body 30.

In a second embodiment of the single-acting cylinder, the positions of the spring and of the compressed air inlet in the inner chamber are reversed, the spring is located at the distal end of the chamber, and the air inlet at the proximal end. The expansion of the spring then actuates the deployment of the rod 32 and of the piston 31 in the second position p2 outside the cylinder body 30, and the compression of the spring actuates the retraction of the rod 32 in the first position p1 into the cylinder body 30.

In an embodiment of the invention, the cylinder body 30 further includes:
a vacuum channel 39C across the thickness of the wall of the cylinder body 30, configured to set the inner vacuum chamber 37 in communication with the inner duct 35, and an outer vacuum port 38C in communication with the cylinder body 30,
at least one pressurization channel 39A, 39B across the thickness of the wall of the cylinder body 30 configured to set said at least one pressurization chamber 33A, 33B and said at least one compressed air port 38A, 38B in communication.

The vacuum channel 39C allows activating the suction effect of the pneumatic suction cup 34 through the tubular rod 32.

Thus, in such an embodiment, the pneumatic cylinder 3 integrates the entirety of the air/vacuum passage circuit, which advantageously contributes to the optimization of the compactness of the device.

In details, in the embodiment of the double-acting cylinder, the first pressurization channel 39A extends from the first compressed air port 38A and communicates with the first pressurization chamber 33A. The first pressurization channel 39A opens into the first chamber 33A preferably onto the end wall forming the first base of the body of the cylinder 30.

The second pressurization channel 39B extends from the second compressed air port 38B and communicates with the second pressurization chamber 33B. Preferably, the second pressurization channel 39B opens onto the end wall forming the second base of the cylinder body 30, and in particular onto an inner face of the cover portion C.

In FIGS. 5, 6, 8 and 9, the air ports 38A and 38B are located next to one another to the left in the figures, one the distal end side of the inner chamber 33, and the vacuum port 38C is located to the right, on the proximal end side of the inner chamber 33. In this embodiment, the air channel 39A conveys air through two inlets at the distal end, in the first pressurization chamber 33A, opposite to two air inlets of the channel 39B at the proximal end, in the second pressurization chamber 33B.

In another embodiment, illustrated in FIGS. 3, 4 and 10, the vacuum port 38C is located between the two air ports 38A, 38B and the pressurization channel 39A conveys air through a unique inlet in the first pressurization chamber 33A, the air channel 39B conveys air through a unique inlet in the second pressurization chamber 33B.

According to an advantageous embodiment of the present disclosure, the vacuum port 38C is secured to the main portion P of the cylinder body 30, and the vacuum channel 39C extends as an extension and internally in the main portion P and in the cover portion C, via a seal J, located between the main portion P and the cover portion C.

In such an embodiment, the seal J enters the main portion P and the cover portion C ensures communication between the outer vacuum port 38C and the vacuum chamber 37.

According to one embodiment, said at least one compressed air port 38A, 38B is secured to the main portion P of the cylinder body 30, at least one pressurization channel extending into the main portion P and into the cover portion C, via a seal J between the main portion P and the cover portion C to ensure communication between said at least one compressed air port 38B and said at least one pressurization chamber 33A, 33B.

In the case of a double-acting cylinder, the second pressurization channel 39B extends from the second compressed air port 38B and communicates with the second pressurization chamber 33B. The second pressurization channel 39A opens onto the end wall forming the second base of the cylinder body, on an inner face of the cover portion C.

Arranging the vacuum port 38C, secured to the main portion P and therefore not directly secured to the cover portion C, allows reducing the bulk of the cover portion C (according to the axis of the rod 32) which may thus be advantageously devoid of any projecting vacuum port 38C.

Arranging the compressed air port 38B secured to the main portion P while ensuring a supply of said at least one pressurization chamber 33A, 33B (in particular of the second pressurization chamber 33B) with compressed air also contributes to reducing the bulk of the cover portion C according to the axis of the rod 32, which may thus advantageously be devoid of any projecting compressed air port 38A, 38B.

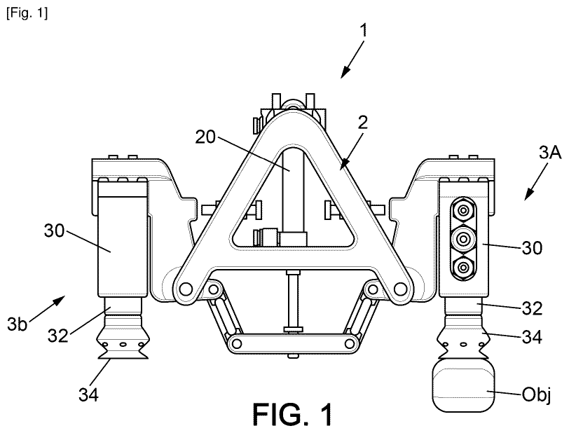

The cover portion C, devoid of any compressed air port 38A, 38B and of any vacuum port 39C may serve as a fastening plate for a support, for example as shown in FIG. 1.

The seal J allows ensuring fluid sealing of the entirety of the cylinder body 30, and also separating the compartments receiving compressed air (the compressed air channels 39A, 39B, and the pressurization chambers 33A, 33B) from those under vacuum (the vacuum channel 39C and the vacuum chamber 37).

Preferably, the seal J is a seal made of elastomer, polymer or rubber, configured to be compressed between the main portion P and the cover portion C, upon mounting of the pneumatic cylinder 3.

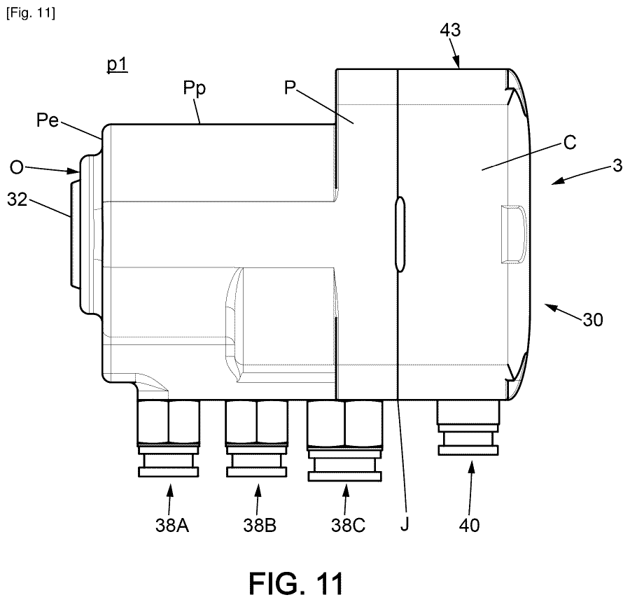

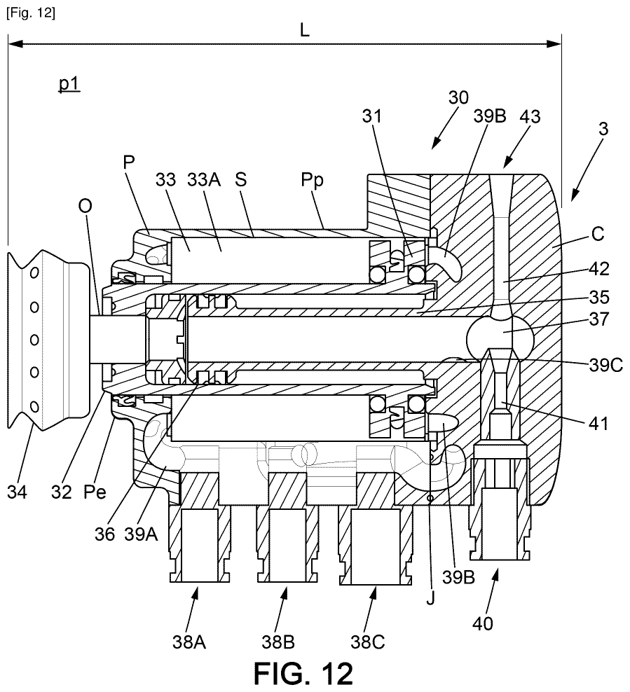

According to another embodiment shown in FIGS. 11 and 12, the cylinder body 30 includes a Venturi system connected, on the one hand, to a compressed air source and, on the other hand, to the outside atmosphere, configured to ensure depressurization of the vacuum chamber 37 in the inner duct 35 from a compressed air source.

Such a Venturi system is particularly advantageous because it requires only a compressed air source, which is already provided to send compressed air in the ports 38A and 38B, and not a vacuum source. Hence, the Venturi system operates in place of the outer vacuum port 38C to actuate the pneumatic suction cup 34. For example, the vacuum port 38C and/or the vacuum channel 39C may be plugged during use of the Venturi.

In this embodiment, the Venturi system then comprises a Venturi inlet port 40 to make compressed air circulate in the cylinder body 30 in a throttling channel 41 with a first diameter smaller than the diameter of the Venturi inlet port 40, up to the vacuum chamber 37, and then towards an outlet channel 42 with a second diameter larger than the first diameter of the throttling channel 41 communicating with the vacuum chamber 37 and as an extension of the throttling channel 41, up to an air outlet 43 of the cylinder body 30. Thus, the throttling channel 41 with a smaller diameter is configured to accelerate the passage of compressed air originating from the Venturi inlet port 40 thereby creating a depression and vacuum by Venturi effect, in the vacuum chamber 37. The outlet channel 42 is configured to evacuate air sent from the throttling channel 41 in the vacuum chamber 37 towards the air outlet 43 out of the cylinder body 30.

In this embodiment, the Venturi inlet port 40 may be secured to the cover portion C of the cylinder body 30 arranged projecting laterally from said cover portion C, and said throttling channel 41 and outlet channel 42 extend inside the cover portion C. The vacuum chamber 37 also extends partially into the cover portion C so as to connect to the two channels 41 and 42, preferably substantially according to an axis perpendicular to the rod 32 of the cylinder.

The overall dimension L of the suction-cup gripper device 1 with a Venturi may typically be larger than the dimension L of the embodiment with no Venturi.

Hence, the complete Venturi system may be entirely integrated into the cover portion C. This particular configuration could enable switching from an embodiment with no Venturi, as shown in FIGS. 1 to 10, into a second embodiment with a Venturi, shown in FIGS. 11 and 12, just by replacing the cover portion C of the cylinder body 30 because the main portion P is the same for both embodiments.

Moreover, the specific design of the cover portion C allows reducing the material costs, because it is not necessary to entirely manufacture a second device to switch from an embodiment with no Venturi into an embodiment with a Venturi. The device is then intended to be easily adapted depending on the selected or available equipment (vacuum and/or compressed air sources).

According to one embodiment, the suction-cup cylinder 3 is used for gripping and handling food products.

In details, the device of the present disclosure is configured so as to have no sharp edge, and so as to be devoid of any holes or retention areas. Thus, the main P and cover C portions are completely smooth, with no right angles or cavities, and with walls sloping with respect to one another to promote the evacuation of the food/liquid residues and deposits during use of the device. Similarly, the pneumatic suction cup 34, as well as fastening thereof to the rod 32, have no retention sites and are suitable for food applications, with materials suitable for food contact complying with the FDA and CE European food standards (the standards EN 1672-2:2005+A1:2009, ISO 14159:2002). Thus, the device complies with the standards 3A and EHEDG.

Hence, such a configuration of the device is particularly advantageous as it is very hygienic. The smooth surfaces with no retention areas enable a complete and rapid cleaning of the device. Indeed, it is essential to clean all parts in order to eliminate any risk of pathogenic contamination of food after several hours of food production.

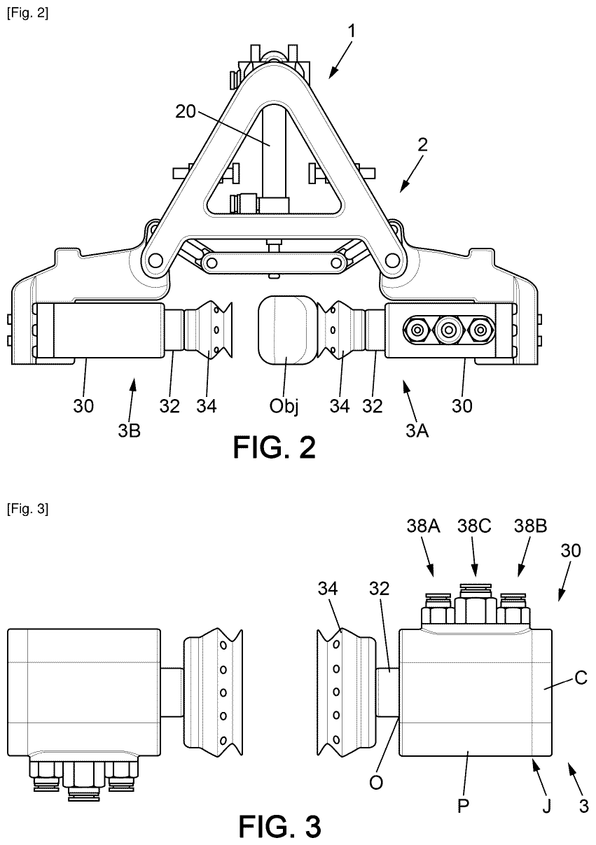

The present disclosure also relates to a flip-over gripper assembly comprising two suction-cup gripper devices 1, as shown in FIGS. 1 and 2.

Such an assembly then comprises two pneumatic cylinders 3 respectively belonging to the two suction-cup grippers, mounted on a support 2. The support 2 includes an actuator 20 configured to switch the two pneumatic cylinders 3:
from a grasp position illustrated in FIG. 1, in which the two pneumatic cylinders 3, the first pneumatic cylinder 3A and the second pneumatic cylinder 3B (in any order), are directed parallel to one another according to a vertical direction, the pneumatic suction cups 34 directed downwards, the grasp position being configured to grasp an object Obj on a surface or to deposit the object Obj on the surface,
into a flip-over position, illustrated in FIG. 2, in which the two pneumatic cylinders 3 are directed coaxially, configured to transfer said object Obj grasped by the pneumatic suction cup 34 of the first pneumatic cylinder 3A to the pneumatic suction cup 34 of the second pneumatic cylinder 3B, or upon deployments of the rods 32 of the first pneumatic cylinder 3A and of the second pneumatic cylinder 3B.

In particular, such an assembly may be mounted on an automated robotic arm, and equipped with shape, dimension recognition devices, etc., such as cameras.

The flip-over gripper assembly according to the present disclosure, including two suction-cup gripper devices 1, is used according to the method for flipping over the object Obj on the surface which comprises the following steps:
/A1/ placing the assembly in the grasping position of the two pneumatic cylinders 3,
/A2/ deploying the rod 32 of said first pneumatic cylinder 3A (or respectively of said second pneumatic cylinder 3B), in the second position p2,
/A3/ grasping the object Obj on the surface with the pneumatic suction cup 34 secured to the deployed rod 32,
/A4/ retracting the rod 32 secured to the pneumatic suction cup 34 carrying the object Obj in the first position p1,
/B1/ placing the assembly in the flip-over position of the two pneumatic cylinders 3,
/B2/ deploying the rods 32 of the two pneumatic cylinders 3 in the second position p2 to transfer the object Obj carried by the pneumatic suction cup 34 of said first pneumatic cylinder 3A, (or respectively of said second pneumatic cylinder 3B), to the pneumatic suction cup 34 of said second pneumatic cylinder 3B, (or respectively of said first pneumatic cylinder 3A),
/B3/ retracting the rods 32 of the two pneumatic cylinders 3 in the first position p1,
/ C1/ placing the assembly in the grasp position of the two pneumatic cylinders 3,
/ C2/ deploying the rod 32 secured to the suction cup 34 carrying the object Obj, in the second position p2 and depositing the object Obj on the surface.

Thus, steps /A1/ to /A4/ consist in grasping and raising the object Obj by the first cylinder 3A from the surface, as illustrated in FIG. 1.

Afterwards, steps /B1/ to /B3/ , illustrated for example in FIG. 2, allow transferring the object Obj from the first cylinder 3A to the second cylinder 3B, so that, in step /B2/ , the object Obj is grasped by the second cylinder 3B by its face opposite to the initial face of grasping by the first cylinder 3A in step /A3/ .

During steps /C1/ and /C2/ , the object Obj thus flipped over is replaced by the second cylinder 3B on the surface.

The present disclosure further relates to a method for manufacturing the suction-cup gripper device 1 described hereinbefore. The cylinder body 30 of the pneumatic cylinder 3, in particular said at least one pressurization channel 39A, 39B, where appropriate, said vacuum channel 39C, and/or the channels forming the Venturi system in particular said throttling channel (41) and said outlet channel 42, is manufactured by additive manufacturing methods.

Additive manufacturing is preferred, because it allows designing the aforementioned pneumatic cylinder 3 device 1, including the different inner channels (pressurization channels 38A, 38B, vacuum channel 38C, throttling channel 41 or air outlet channel 42).

Such a 3D printing additive manufacturing technique confers on the device a very compact ingenious design. In addition, it is very advantageous because it is rapid, simple to implement and the parts can be manufactured on demand without requiring any specific infrastructure, unlike for example manufacturing by molding which requires a dedicated mold for each part.

Thus, the number of parts to be manufactured necessary to the device is reduced, and the usable materials are common and inexpensive. In particular, to manufacture the pneumatic cylinder 3, it is possible to use plastic materials such as PLA or ABS plastic, or metals, such as titanium or stainless steel.

In the context of an application in the agri-food industry, the material may advantageously consist of metal detectable polyamide PA plastic, injected by selective laser sintering (SLS) printing.

Finally, although the device 1 of the present disclosure is designed in order to reduce bulk thereof, it is quite possible to design the pneumatic cylinder 3, as well as all its elements, in particular its rod 32, in larger dimensions, allowing raising and carrying objects Obj that are larger/heavier, or requiring a longer telescopic rod. It is also possible to design a device with several telescopic rods.

### LIST OF THE REFERENCE SIGNS

1. Suction-cup gripper device,
2. Support,
20. Actuator,
3. Pneumatic cylinder,
3A. First pneumatic cylinder,
3B. Second pneumatic cylinder,
30. Cylinder body,
31. Piston,
32. Tubular rod,
33. Inner chamber,
33A. First pressurization chamber,
33B. Second pressurization chamber,
34. Pneumatic suction cup,
35. Inner duct,
36. Sliding seal,
37. Vacuum chamber,
38A., 38B. Compressed air ports,
38C. Vacuum port,
39A., 39B. Pressurization channels,
39C. Vacuum channel,
40. Venturi inlet port,
41. Throttling channel,
42. Outlet channel,
43. Air outlet,
S. Inner surface,
O. Cylinder body opening,
P. Main portion,
Pe. End wall,
Pp. Peripheral wall,
C. Cover portion,
J. Seal,
DL. Longitudinal direction,
L. Dimension,
Obj. Object,
p1. First position,
p2. Second position.

1. A suction-cup gripper device including:
at least one pneumatic cylinder including a cylinder body, a piston slidably mounted in a first inner chamber of the cylinder body, and a rod secured to the piston extending from a proximal end from the inner chamber to the outside of the cylinder body, throughout an opening in the cylinder body,
a pneumatic suction-cup system including a pneumatic suction cup secured to the distal end of the rod, and a circuit for depressurizing the pneumatic suction cup and wherein the piston and rod assembly is configured to selectively retract in a first position into the cylinder body, and deploy in a second position out of the cylinder body and wherein the depressurization circuit of the pneumatic suction cup includes:
the rod of the piston which is tubular, and communicating at the distal end with the pneumatic suction cup,
an inner duct, coaxial with the rod of the pneumatic cylinder, secured to the body of the cylinder, penetrating the tubular rod from said proximal end, connected in a fluid-sealed manner with an inner surface of the rod via a sliding seal system, forming a vacuum chamber, and wherein the piston is annular, configured to surround the pneumatic cylinder rod and the inner duct, and to sweep at least one pressurization chamber of the cylinder body connected to at least one compressed air port external to the cylinder body, annular, delimited between the inner duct and an inner surface of the cylinder body configured to slide with the piston.

2. The device according to claim 1, wherein the pneumatic suction cup includes a longitudinal direction perpendicular to the axis of the rod, and an anti-rotation system configured to prevent the rotation of the rod and of the pneumatic suction cup relative to the body of the cylinder, about the axis of the rod.

3. The device according to claim 2, wherein the anti-rotation system includes the cylinder body, with a non-circular section, and the piston, with a non-circular complementary shape.

4. The device according to claim 1, wherein the cylinder body includes:
a main portion including an end wall carrying said opening sealingly crossed by the rod of the piston, said end wall being extended by a peripheral wall, said peripheral wall internally forming the inner surface of the cylinder body configured to slidably cooperate with the piston, up to a second opening, configured to enable extension of the piston, and
a cover portion, configured to sealingly close said second opening, said cover portion being secured to the inner duct at a proximal end of the inner duct opposite to a distal end of the inner duct cooperating with the sliding seal system.

5. The device according to claim 1, wherein said pneumatic cylinder is a double-acting cylinder, said at least one pressurization chamber including:
a first pressurization chamber defined in the cylinder body, on a first side of the piston, the first chamber being connected to an outer first compressed air port, and
a second pressurization chamber defined in the cylinder body, on a second side of the piston, the second chamber being connected to an outer second compressed air port.

6. The device according to claim 1, wherein the cylinder body includes:
a vacuum channel, across the thickness of the wall of the cylinder body, configured to set the inner vacuum chamber in communication with the inner duct and an outer vacuum port in communication with the cylinder body,
at least one pressurization channel, across the thickness of the wall of the cylinder body configured to set said at least one pressurization chamber and said at least one compressed air port in communication, in particular a first compressed air channel communicating with the first pressurization chamber and a second compressed air channel communicating with the second pressurization chamber.

7. The device according to claim 4, wherein the cylinder body includes:
a vacuum channel, across the thickness of the wall of the cylinder body, configured to set the inner vacuum chamber in communication with the inner duct and an outer vacuum port in communication with the cylinder body,
at least one pressurization channel, across the thickness of the wall of the cylinder body configured to set said at least one pressurization chamber and said at least one compressed air port in communication, in particular a first compressed air channel communicating with the first pressurization chamber and a second compressed air channel communicating with the second pressurization chamber,
wherein said outer vacuum port is secured to the main portion of the cylinder body, said vacuum channel extending in the main portion and in the cover portion, via a seal between the main portion and the cover portion to ensure communication between the outer port and the vacuum chamber, and/or
wherein said at least one compressed air port is secured to the main portion of the cylinder body, said at least one pressurization channel extending in the main portion and in the cover portion, via a seal between the main portion and the cover portion to ensure communication between said at least one compressed air port and one of said at least one pressurization chamber.

8. The device according to claim 7, wherein said compressed air port, in particular the first compressed air port and the second compressed air port on the one hand, and the vacuum port, on the other hand, are secured to the main portion, arranged projecting laterally, and according to a bulk according to the direction of the rod contained within the limits of the main portion, the cover portion being devoid of a compressed air port and of a vacuum port projecting outside.

9. The device according to claim 1, wherein the cylinder body includes a Venturi system connected, on the one hand, to a compressed air source and, on the other hand, to the outside atmosphere, configured to ensure depressurization of the vacuum chamber in the inner duct from a compressed air source.

10. The device according to claim 9, wherein the Venturi system comprises a Venturi inlet port to make compressed air circulate in the cylinder body in a throttling channel with a first diameter smaller than the diameter of the Venturi inlet port, up to the vacuum chamber, then towards an outlet channel with a second diameter larger than the first diameter of the throttling channel communicating with the vacuum chamber and as an extension of the throttling channel, up to an air outlet of the cylinder body, said throttling channel with a smaller diameter being configured to accelerate the passage of compressed air originating from the Venturi inlet port thereby creating vacuum in said vacuum chamber, and said outlet channel being configured to evacuate the air sent from the throttling channel in the vacuum chamber towards the air outlet outside the cylinder body.

11. The device according to claim 10, wherein the cylinder body includes:
a main portion including an end wall carrying said opening sealingly crossed by the rod of the piston, said end wall being extended by a peripheral wall, said peripheral wall internally forming the inner surface of the cylinder body configured to slidably cooperate with the piston, up to a second opening, configured to enable extension of the piston, and
a cover portion configured to sealingly close said second opening, said cover portion being secured to the inner duct at a proximal end of the inner duct opposite to a distal end of the inner duct cooperating with the sliding seal system,
and wherein the Venturi inlet port is secured to the cover portion of the cylinder body arranged projecting laterally from said cover portion, and said throttling channel and outlet channel extend inside the cover portion.

12. A method for using the device according to claim 1, wherein the pneumatic cylinder is used for gripping and handling food products.

13. A method for using the device according to claim 10, wherein the pneumatic cylinder is used for gripping and handling food products.

14. A flip-over gripper assembly including two devices according to claim 1, respectively with two pneumatic cylinders mounted on a support, and including an actuator configured to switch the two pneumatic cylinders:
from a grasping position in which the two pneumatic cylinders, a first pneumatic cylinder and a second pneumatic cylinder, are directed parallel to one another according to a vertical direction, the pneumatic suction cups directed downwards, the grasp position being configured to grasp an object on a surface or to deposit an object on a surface,
into a flip-over position in which the two pneumatic cylinders are directed coaxially, configured to transfer said object grasped by the pneumatic suction cup of the first pneumatic cylinder to the pneumatic suction cup of the second pneumatic cylinder upon deployment of the rod of the first pneumatic cylinder or of the second pneumatic cylinder or upon deployments of the rods of the first pneumatic cylinder and of the second pneumatic cylinder.

15. A method for flipping over an object on a surface implementing the assembly of claim 14 and comprising the following steps:
/A1/ placing the assembly in the grasping position of the two pneumatic cylinders,
/A2/ deploying the rod of said first pneumatic cylinder, or of said second pneumatic cylinder, in the second position,
/A3/ grasping the object on the surface with the pneumatic suction cup secured to the deployed rod,
/A4/ retracting the rod secured to the pneumatic suction cup carrying the object in the first position,
/B1/ placing the assembly in the flip-over position of the two pneumatic cylinders,
/B2/ deploying the rods of the two pneumatic cylinders in the second position to transfer the object carried by the pneumatic suction cup of said first pneumatic cylinder, or of said second pneumatic cylinder, to the pneumatic suction cup of said second pneumatic cylinder, or of said first pneumatic cylinder, respectively,
/B3/ retracting the rods of the two pneumatic cylinders in the first position,
/C1/ placing the assembly in the grasping position of the two pneumatic cylinders,
/C2/ deploying the rod secured to the suction cup carrying the object, in the second position and depositing the object on the surface.

16. A method for manufacturing a suction-cup gripper device according to claim 1, wherein the cylinder body of the pneumatic cylinder vacuum channel, is manufactured by additive manufacturing.

17. A method for manufacturing a suction-cup gripper device according to claim 10, wherein the cylinder body of the pneumatic cylinder is manufactured by additive manufacturing.
